(19) United States
(12) Patent Application Publication
(10) Pub. No.: US 2025/0243366 A1
(43) Pub. Date: Jul. 31, 2025

(54) A RECYCLABLE AND SORTABLE THERMOPLASTIC COMPOSITION

(71) Applicant: UPM-Kymmene Corporation, Helsinki (FI)

(72) Inventors: Barbara GALL, Helsinki (FI); Florian DIEHL, Helsinki (FI)

(21) Appl. No.: 18/702,758

(22) PCT Filed: Oct. 21, 2021
(86) PCT No.: PCT/FI2021/050705

§ 371 Date: Apr. 18, 2024

(51) Int. Cl. C08L 97/00; C08J 3/22

(52) U.S. Cl. CPC C08L 97/005; C08J 3/226; C08J 2323/06; C08J 2323/12; C08J 2325/06; C08J 2377/00; C08J 2397/00; C08L 2207/20

(57) ABSTRACT

Disclosed is a thermoplastic composition comprising at least one polymer and a lignin-based filler, wherein—the color of the thermoplastic composition is represented by an L value of at most 36, an a value of at most 10, and a b value of at most 15; and—the thermoplastic composition exhibits a maximum reflection intensity value in the near-infrared wavelength range of 1450-2450 nm of the electromagnetic spectrum that is equal to or greater than 5% reflection intensity when determined with a near-infrared detection system. Further is disclosed a method for producing a thermoplastic composition, and the use of the lignin-based filler. Further is disclosed an article and the use of the thermoplastic composition.

### FIELD OF THE INVENTION

The present disclosure relates to a thermoplastic composition. The present disclosure further relates to a method for producing a thermoplastic composition comprising at least one polymer and a lignin-based filler. The present disclosure further relates to the use of a lignin-based filler. The present disclosure further relates to an article and to the use of the thermoplastic composition.

### BACKGROUND OF THE INVENTION

In the light of sustainability and circular economy it is desired to recycle thermoplastic compositions or materials, such as packaging materials, in a closed loop. Carbon black is commonly used as the pigment or filler in black colored plastics. Carbon black filled polymer compositions, however, cannot be sorted and recycled in recycling facilities as detection of the polymer used in the thermoplastic composition with near infrared (NIR) detection system is not possible due to strong absorbance of carbon black. Therefore, the inventors have recognized a need for other black coloring fillers or pigments, which allow sorting of the polymers in the composition and thus enable recycling of the thermoplastic composition.

### SUMMARY

A thermoplastic composition comprising at least one polymer and a lignin-based filler is disclosed. The color of the thermoplastic composition is represented by an L value of at most 36, an a value of at most 10, and a b value of at most 15 as determined by DIN EN ISO 11664. The thermoplastic composition exhibits a maximum reflection intensity value in the near-infrared wavelength range of 1450-2450 nm of the electromagnetic spectrum that is equal to or greater than 5% reflection intensity when determined with a near-infrared detection system.

Further is disclosed a method for producing a thermoplastic composition comprising at least one polymer and a lignin-based filler, wherein the method comprises combining the at least one polymer and the lignin-based filler to form a thermoplastic composition, wherein
the color of the thermoplastic composition is represented by an L value of at most 36, an a value of at most 10, and a b value of at most 15 as determined by DIN EN ISO 11664; and
the thermoplastic composition exhibits a maximum reflection intensity value in the near-infrared wavelength range of 1450-2450 nm of the electromagnetic spectrum that is equal to or greater than 5% reflection intensity when determined with a near-infrared detection system.

Further is disclosed the use of the lignin-based filler for the production of a thermoplastic composition comprising at least one polymer and the lignin-based filler, wherein
the color of the thermoplastic composition is represented by an L value of at most 36, an a value of at most 10, and a b value of at most 15 as determined by DIN EN ISO 11664; and
the thermoplastic composition exhibits a maximum reflection intensity value in the near-infrared wavelength range of 1450-2450 nm of the electromagnetic spectrum that is equal to or greater than 5% reflection intensity when determined with a near-infrared detection system, and wherein the thermoplastic composition can be detected by a near-infrared detection system such that the thermoplastic composition can be sorted from a mixture of articles.

Further is disclosed an article comprising the thermoplastic composition as defined in the current specification.

Further is disclosed the use of the thermoplastic composition as defined in the current specification in a packaging, a housing, an automotive part, an aviation part, a marine part, a machine part, a sports equipment, a sports equipment part, a leisure equipment, a leisure equipment part, a tool, a part of a tool, a pipe, a membrane, a tube, a fitting, a bottle, a film, a bag, a sack, a textile, a rope, a container, a tank, an electrical component, an electronic component, a part for energy generation, a toy, an appliance, a kitchenware, a tableware, a flooring, a fabric, a medical application, a food contact material, a construction material, a drinking water application, and/or a furniture.

### BRIEF DESCRIPTION OF THE DRAWINGS

The accompanying drawings, which are included to provide a further understanding of the embodiments and constitute a part of this specification, illustrate various embodiments. In the drawings:

FIGS. 1-7 disclose the results of the near-infrared intensity measurements carried out in the examples.

### DETAILED DESCRIPTION

A thermoplastic composition comprising at least one polymer and a lignin-based filler is disclosed. The color of the thermoplastic composition is represented by an L value of at most 36, an a value of at most 10, and a b value of at most 15 as determined by DIN EN ISO 11664. The thermoplastic composition exhibits a maximum reflection intensity value in the near-infrared wavelength range of 1450-2450 nm of the electromagnetic spectrum that is equal to or greater than 5% reflection intensity when determined with a near-infrared detection system.

Further is disclosed a method for producing a thermoplastic composition comprising at least one polymer and a lignin-based filler, wherein the method comprises combining the at least one polymer and the lignin-based filler to form a thermoplastic composition, wherein
the color of the thermoplastic composition is represented by an L value of at most 36, an a value of at most 10, and a b value of at most 15 as determined by DIN EN ISO 11664; and
the thermoplastic composition exhibits a maximum reflection intensity value in the near-infrared wavelength range of 1450-2450 nm of the electromagnetic spectrum that is equal to or greater than 5% reflection intensity when determined with a near-infrared detection system.

Further is disclosed the use of the lignin-based filler for the production of a thermoplastic composition comprising at least one polymer and the lignin-based filler, wherein
the color of the thermoplastic composition is represented by an L value of at most 36, an a value of at most 10, and a b value of at most 15 as determined by DIN EN ISO 11664; and
the thermoplastic composition exhibits a maximum reflection intensity value in the near-infrared wavelength range of 1450-2450 of nm the electromagnetic spectrum that is equal to or greater than 5% reflection intensity when determined with a near-infrared detection system, and wherein the thermoplastic composition can be detected by a near-infrared detection system such that the thermoplastic composition can be sorted from a mixture of articles.

The expression “mixture of articles” should be understood in this specification, unless otherwise stated, as referring to a mixture comprising articles of different origin. Articles of different origin may be e.g. articles of different kinds of thermoplastic compositions. The mixture of articles may contain different kinds of thermoplastic compositions prepared from different polymers and fillers.

Further is disclosed an article comprising the thermoplastic composition as defined in the current specification. In one embodiment, thermoplastic composition has been shaped into the article by extrusion, injection molding, compression molding, blow molding, injection blow molding, injection stretch blow molding, thermoforming, vacuum forming, melt spinning, electrospinning, melt blowing, film blowing, film casting, extrusion coating, rotational molding, coextrusion, laminating, calendering, fused deposition modeling, or by any combination of these.

Further is disclosed the use of the thermoplastic composition as defined in the current specification in a packaging, a housing, an automotive part, an aviation part, a marine part, a machine part, a sports equipment, a sports equipment part, a leisure equipment, a leisure equipment part, a tool, a part of a tool, a pipe, a membrane, a tube, a fitting, a bottle, a film, a bag, a sack, a textile, a rope, a container, a tank, an electrical component, an electronic component, a part for energy generation, a toy, an appliance, a kitchenware, a tableware, a flooring, a fabric, a medical application, a food contact material, a construction material, a drinking water application, and/or a furniture.

In one embodiment, the thermoplastic composition is a recyclable and sortable thermoplastic composition. In one embodiment, the thermoplastic composition is a recyclable thermoplastic composition. In one embodiment, the method comprises producing a recyclable and sortable thermoplastic composition. In one embodiment, the method comprises producing a recyclable thermoplastic composition.

By the expression that the thermoplastic composition is “sortable” should be understood in this specification, unless otherwise stated, as referring to the possibility of sorting the thermoplastic composition from the mixture of articles and thus enabling the thermoplastic composition to be recycled and reused.

In one embodiment, the thermoplastic composition can be detected by a near-infrared detection system such that the thermoplastic composition can be sorted from a mixture of articles.

In one embodiment, the thermoplastic composition does not comprise carbon black.

The inventors surprisingly found out that by using a lignin-based material as the filler in a thermoplastic composition, in the absence of carbon black, one is able to detect the thermoplastic composition by a near-infrared detection system and the thermoplastic composition can thus be sorted after its use from a mixture of articles. The inventors surprisingly found out that the lignin-based filler does not mask the polymer in the thermoplastic composition as is the situation when using e.g. carbon black as the filler, whereby a near-infrared detection system may be used to recognize the thermoplastic composition.

The maximum reflection intensity value in the near-infrared wavelength range may be determined by using a near-infrared measurement device. In near-infrared (NIR) spectroscopy, unique features of the studied material or composition are observed by illuminating the material with a specific wavelength of infrared light. A specific pattern of this invisible light is reflected back by the object, and this pattern is unique for each material, i.e. like a fingerprint. Infrared light can be detected with infrared detectors that convert the reflected radiation into an electrical signal that may be presented as a graph.

Thus, the thermoplastic composition, when subjected to near-infrared illumination, may be characterized by a reflection pattern and may thus exhibit a maximum reflection near-infrared intensity value. From this reflection pattern one may determine the highest peak, i.e. the maximum reflection intensity value. The maximum reflection intensity value in the near-infrared wavelength range may thus be determined by a near-infrared measurement device. The near-infrared detection system may be a near infrared spectroscopy device. An example of a near-infrared measurement system can be mentioned the one provided by trinamix GmbH (Ludwigshafen, Germany), i.e. trinamix NIR Spectrometer (software package: general plastic). The near-infrared device may comprise at least an illumination source, a detector, and a software package for processing the measured signals to graphs, e.g. reflection graphs in a certain wavelength area. The software package may comprise also a data reference library for different polymers, thus enabling the software to compare the measurement results to the data in the library and give feedback on the polymer type. This may be called “scoring”.

In one embodiment, the thermoplastic composition exhibits a maximum reflection intensity value in the near-infrared wavelength range of 1450-2450 nm of the electromagnetic spectrum that is equal to or greater than 8%, or equal to or greater than 10%, or equal to or greater than 15%, or equal to or greater than 20%, or equal to or greater than 25%, reflection intensity when determined with a near-infrared detection system. In one embodiment, the thermoplastic composition exhibits a maximum reflection near-infrared intensity value in the wavelength range of 1450-2450 nm, or in the wavelength range of 1450-2100 nm, or in the wavelength range of 1450-1800 nm, of the electromagnetic spectrum. In one embodiment, the thermoplastic composition exhibits a maximum reflection near-infrared intensity value in the wavelength range of 1450-2450 nm, or in the wavelength range of 1450-2100 nm, or in the wavelength range of 1450-1800 nm, of the electromagnetic spectrum that is equal to or greater than 5%, or equal to or greater than 8%, or equal to or greater than 10%, or equal to or greater than 15%, or equal to or greater than 20%, or equal to or greater than 25%, reflection intensity when determined with a near-infrared detection system.

In one embodiment, the thermoplastic composition exhibits a near-infrared (NIR) specimen contrast that is equal to or greater than 3.0, or 5.0, or 6.0, or 9.0, in the wavelength range of 1450-2450 nm. The NIR specimen contrast describes the ability of spectral features like bands or fingerprints to stand out against the background or other adjacent details and may be determined by the relationship between the highest and lowest intensity in the NIR spectrum by the following equation:

(Imax−Imin)/Imin,
wherein
Imax=maximum intensity (highest intensity)
Imin=minimum intensity (lowest intensity)

A thermoplastic composition, or thermosoftening plastic composition as it may also be called, is a plastic polymer material that becomes pliable or moldable at a certain elevated temperature and solidifies upon cooling.

The thermoplastic composition may be prepared by using a polymer and a lignin-based filler. Further components or materials, such as additives, lubricants, stabilizers, antioxidants, other fillers, etc., may also be used for preparing the thermoplastic composition.

In one embodiment, combining the at least one polymer and the lignin-based filler comprises preparing subsequently compounding the a masterbatch, and masterbatch with either the same or a different polymer and optionally further additives. combining the at least one polymer and the lignin-based filler comprises preparing a masterbatch and then compounding the masterbatch with the at least one polymer. In one embodiment, combining the at least one polymer and the lignin-based filler comprises directly compounding the polymer and the lignin-based filler.

When preparing the thermoplastic composition a so-called masterbatch may first be prepared by using polymer and the lignin-based filler. The masterbatch may be prepared by mixing the polymer and the lignin-based filler at an elevated temperature. Also other additives, lubricants, stabilizer, antioxidants, other fillers, etc. as needed may be included in the masterbatch. A masterbatch is generally considered a solid product (normally of plastic, rubber, or elastomer) in which pigments or fillers are optimally dispersed at high concentration in a carrier material. The carrier material is compatible with the main plastic in which it will be blended during molding, whereby the final plastic product, i.e. the thermoplastic composition, obtains the color or properties from the masterbatch.

Alternatively, the thermoplastic composition is directly compounded at an elevated temperature from the polymer and the lignin-based filler. Also other additives, lubricants, stabilizers, antioxidants, other fillers, etc. as needed may be directly compounded with the polymer and the lignin-based filler.

The temperature used when combining the at least one polymer and the lignin based filler may vary depending on the type of polymer used. The suitable temperature to be used for each polymer is readily available to the person skilled in the art. Also the polymer providers define suitable processing temperatures for different polymers. Generally, temperatures of e.g. 150-440° C., or 180-350° C., or 200-300° C., may be used.

The thermoplastic composition may contain 0.1-65 weight-%, or 0.3-60 weight-%, or 0.5-50 weight-%, or 1-40 weight-%, or 1.2-30 weight-%, or 1.5-20 weight-%, or 2-10 weight-%, or 2.5-5 weight-%, of the lignin-based filler based on the total weight of the thermoplastic composition.

The “total weight” should in this specification be understood, unless otherwise stated, as the weight of all the components of the thermoplastic composition including possible moisture.

The thermoplastic composition may comprise at least one polymer, e.g. at least two different polymers, at least three different polymers, at least four different polymers etc. The thermoplastic composition may comprise a polymer or one polymer.

In one embodiment, the thermoplastic composition comprises a polymer and a lignin-based filler. In one embodiment, the thermoplastic composition comprises one polymer and a lignin-based filler.

The polymer may be any polymer selected from the group of thermoplastic polymers or a combination of different thermoplastic polymers. The polymer may be polyethylene, polypropylene, polystyrene, ethylene-vinyl acetate (EVA), polybutylene adipate terephthalate (PBAT), polyamide, polyacrylate, polyester, acrylonitrile butadiene styrene (ABS), polycarbonate, polylactic acid (PLA), or polyvinyl chloride (PVC), or any combination or mixture of these. I.e. one type of polymer may be used for producing the thermoplastic composition or a combination of two or more different polymers may be used.

By the expression “lignin-based filler” should be understood in this specification, unless otherwise stated, as referring to a filler that has been prepared from lignin. I.e. a lignin material has been used for preparing the lignin-based filler.

In one embodiment, the lignin-based filler comprises or consists of lignin. In one embodiment, the lignin-based filler is prepared from lignin subjected to hydrothermal carbonization treatment. The lignin used for preparing the lignin-based filler may be selected from a group consisting of kraft lignin, steam explosion lignin, biorefinery lignin, supercritical separation lignin, hydrolysis lignin, flash precipitated lignin, biomass originating lignin, lignin from alkaline pulping process, lignin from soda process, lignin from organosolv pulping, lignin from alkali process, lignin from enzymatic hydrolysis process, and any combination thereof. In one embodiment, the lignin is wood based lignin. The lignin can originate from softwood, hardwood, annual plants or from any combination thereof.

By “kraft lignin” is to be understood in this specification, unless otherwise stated, lignin that originates from kraft black liquor. Black liquor is an alkaline aqueous solution of lignin residues, hemicellulose, and inorganic chemicals used in a kraft pulping process. The black liquor from f the pulping process comprises components originating from different softwood and hardwood species in various proportions. Lignin can be separated from the black liquor by different, techniques including e.g. precipitation and filtration. Lignin usually begins precipitating at pH values below 11-12. Different pH values can be used in order to precipitate lignin fractions with different properties. These lignin fractions differ from each other by molecular weight distribution, e.g. Mw and Mn, polydispersity, hemicellulose and extractive contents. The molar mass of lignin precipitated at a higher pH value is higher than the molar mass of lignin precipitated at a lower pH value. Further, the molecular weight distribution of lignin fraction precipitated at a lower pH value is wider than of lignin fraction precipitated at a higher pH value. The precipitated lignin can be purified from inorganic impurities, hemicellulose and wood extractives using acidic washing steps. Further purification can be achieved by filtration.

The term “flash precipitated lignin” should be understood in this specification as lignin that has been precipitated from black liquor in a continuous process by decreasing the pH of a black liquor flow, under the influence of an over pressure of 200-1000 kPa, down to the precipitation level of lignin using a carbon dioxide based acidifying agent, preferably carbon dioxide, and by suddenly releasing the pressure for precipitating lignin. The method for producing flash precipitated lignin is disclosed in patent application FI 20106073. The residence time in the above method is under 300 s. The flash precipitated lignin particles, having a particle diameter of less than 2 μm, form agglomerates, which can be separated from black liquor using e.g. filtration. The advantage of the flash precipitated lignin is its higher reactivity compared to normal kraft lignin. The flash precipitated lignin can be purified and/or activated if needed for the further processing.

The lignin may be derived from an alkali process. The alkali process can begin with liquidizing biomass with strong alkali followed by a neutralization process. After the alkali treatment, the lignin can be precipitated in a similar manner as presented above.

The lignin may be derived from steam explosion. Steam explosion is a pulping and extraction technique that can be applied to wood and other fibrous organic material.

By “biorefinery lignin” is to be understood in this specification, unless otherwise stated, lignin that can be recovered from a refining facility or process where biomass is converted into fuel, chemicals and other materials.

By “supercritical separation lignin” is to be understood in this specification, unless otherwise stated, lignin that can be recovered from biomass using supercritical fluid separation or extraction technique. Supercritical conditions correspond to the temperature and pressure above the critical point for a given substance. In supercritical conditions, distinct liquid and gas phases do not exist. Supercritical water or liquid extraction is a method of decomposing and converting biomass into cellulosic sugar by employing water or liquid under supercritical conditions. The water or liquid, acting as a solvent, extracts sugars from cellulose plant matter and lignin remains as a solid particle.

The lignin may be derived from a hydrolysis process. The lignin derived from the hydrolysis process can be recovered from paper-pulp or wood-chemical processes.

The lignin may originate from an organosolv process. Organosolv is a pulping technique that uses an organic solvent to solubilize lignin and hemicellulose.

In one embodiment, the lignin-based filler comprises or consists of lignin. In one embodiment, the lignin-based filler is prepared from lignin subjected to hydrothermal carbonization treatment (HTC). The hydrothermal carbonization treatment of lignin refers to a thermochemical conversion process of lignin-containing material in an aqueous suspension. Hydrothermal carbonization treatment of lignin produces lignin derivatives having high carbon content and functional groups.

In one embodiment, the lignin-based filler is prepared from lignin derived from enzymatic hydrolysis process and/or from a Kraft process. In one embodiment, the lignin-based filler is prepared from lignin derived from enzymatic hydrolysis process and/or from a Kraft process and subjected to the hydrothermal carbonization treatment. In one embodiment, the lignin-based filler is prepared from lignin derived from enzymatic hydrolysis process and subjected to the hydrothermal carbonization treatment. In one embodiment, the lignin-based filler is prepared from lignin derived from a Kraft process and subjected to the hydrothermal carbonization treatment.

In one embodiment, the enzymatic hydrolysis process comprises enzymatic hydrolysis of a plant-based feedstock, such as a wood-based feedstock. In one embodiment, the enzymatic hydrolysis process comprises enzymatic hydrolysis of cellulose. In one embodiment, the lignin-based filler is prepared from lignin derived from pulping of wood, e.g. Kraft lignin.

The slurry comprising lignin-based filler as disclosed in the current specification may be prepared as disclosed below. The lignin to be used may be derived from e.g. a process wherein the lignin is formed in enzymatic hydrolysis of lignocellulosic feedstock or the lignin may be derived from a Kraft process. Also other lignin sources may be used.

The derived lignin may be dissolved in alkaline solution, such as NaOH. The dissolution may be accomplished by heating the mixture of lignin and alkaline solution to about 80° C., adjusting the pH to a value above 7, such as 9-11, and mixing the mixture of lignin and alkaline solution for a predetermined time. The mixing time may be continued for about 2-3 hours. The exact pH value is determined based on the grade target of the product.

The dissolved lignin may then be subjected to hydrothermal carbonization treatment (HTC).

The hydrothermal carbonization treatment may take place in a reactor (HTC reactor), or if needed, in several parallel reactors, working in a batchwise manner. The dissolved lignin may be pre-heated before being entered in the HTC reactor(s). The temperature in the HTC reactor(s) may be 150-250° C. and the pressure may be 20-30 bar. The residence time in the HTC reactor(s) may be about three to six hours. In the HTC reactor, the lignin is carbonized, whereby a stabilized lignin derivative with a high specific surface area may be precipitated. The formed slurry comprising the carbonized lignin may then be removed and cooled.

Consequently, a slurry comprising lignin-based filler is formed.

The slurry comprising lignin-based filler may be fed to a separation unit, wherein the precipitated lignin may be separated from the slurry. The separated lignin-based filler may be dried and recovered. Before drying, the lignin-based filler may be, if needed, washed. The recovered lignin based filler may be treated further, e.g. crushed, dried further, milled etc. before using as the lignin-based filler.

During the above described process lignin polymers are connected to each other. Thus, the lignin-based filler may be considered to comprise or consist of lignin polymers that are linked together. Lignin polymers that are connected or linked together may not be soluble anymore. However, smaller lignin polymer chains still remain soluble and thus can be subjected to standard analytical techniques like size exclusion chromatography or nuclear magnetic resonance spectroscopy (NMR spectroscopy), which require the analyte to be dissolved in a solvent. Thus, different properties of the soluble fraction of the lignin-based filler may be determined.

In one embodiment, the starting material for preparing the lignin-based filler is lignin taken from enzymatic hydrolysis process. Enzymatic hydrolysis is a process, wherein enzyme(s) assist(s) in cleaving bonds in molecules with the addition of elements of water. In one embodiment, the enzymatic hydrolysis comprises enzymatic hydrolysis of cellulose.

In one embodiment, the lignin-based filler is prepared from lignin derived from enzymatic hydrolysis process that is subjected to hydrothermal carbonization treatment.

In one embodiment, the lignin-based filler comprises ash in a total amount of 0.1-2.8 weight-%, or 0.2-2.5 weight-%, or 0.3-1.5 weight-%, or 0.4-1.0 weight-%. The ash content can be determined according to the standard DIN 51719.

The inventors surprisingly found out that when e.g. lignin from enzymatic hydrolysis process is used for producing the lignin-based filler, one is able to lower the ash content of the lignin-based filler. The lower ash content has the added utility of e.g. higher purity of the lignin-based filler.

The lignin-based filler may comprise carbon in a total amount of 59-70 weight-%. In one embodiment, the lignin-based filler comprises carbon in a total amount of 59-70 weight-%, or 62-70 weight-%, or 63-69 weight-%, or 64-68 weight-%. The amount of carbon in the lignin-based filler may be determined according to standard DIN 51732 (1997).

In one embodiment, the solubility of the lignin-based filler in 0.1 M NaOH is 1-45 weight-%, or 3-35 weight-%, or 5-30 weight-%. The solubility may be measured in the following manner: First a sample is dried at a temperature of 60° C. for four hours. A sample mass of 0.5 gram is weighed and suspended in 50 ml of 0.1 M NaOH at a concentration of 1% having a temperature of 22° C. Mixing is continued for 1 hour, where after the sample is placed on a glass microfiber paper (1.6 μm) and the filter paper with the sample is dried at a temperature of 60° C. for 2 hours. The portion of the sample has which has dissolved can be determined gravimetrically.

In one embodiment, the lignin-based filler has a weight average molecular weight (Mw) of 1000-4000 Da, or 1300-3700 Da, or 1700-3200 Da, or 2500-3000 Da, or 2600-2900 Da, or 2650-2850 Da, when determined based on the soluble fraction of the lignin-based filler. The weight average molecular weight may be determined with size exclusion chromatography (SEC) by using 0.1 M NaOH as eluent and a sample amount of about 1 mg/ml, which is dissolved in 0.1 M NaOH. The molecular weights are measured against polystyrenesulfonate standards. UV detector at wavelength of 280 nm is used.

The polydispersity index (PDI) of the lignin-based filler may be 1.5-5.0, or 1.8-4.5, or 1.9-4.3, or 2.1-4.0, or 2.4-3.5, or 2.6-3.2, when determined based on the soluble fraction of the lignin-based filler. The polydispersity index may be determined by size-exclusion chromatography (SEC). The PDI is a measure of the distribution of molecular mass in a given polymer sample. The PDI is calculated as the weight average molecular weight (Mw) divided by the number average molecular weight (Mn). PDI indicates the distribution of individual molecular masses in a batch of polymers.

The lignin-based filler may have a STSA number of 3-150 m²/g, or 5-100 m²/g, or 7-60 m²/g, or 20-30 m²/g. The STSA number may be determined according to standard ASTM D6556.

In one embodiment, the lignin-based filler has a density of at most 1.5 g/cm³. In one embodiment, the lignin-based filler has a density of 1.0-1.5 g/cm³, or 1.1-1.4 g/cm³. The density may be determined according to standard ISO 21687.

The lignin-based filler has the added utility of providing the thermoplastic composition with a black color that otherwise resembles the color of the thermoplastic composition prepared by using carbon black as the filler.

In one embodiment, the color of the thermoplastic composition is represented by an L value of at most 36, an a value of at most 10, and a b value of at most 15 as determined by DIN EN ISO 11664.

In one embodiment, the color of the thermoplastic composition is represented by an L value of at most 36, or at most 35, or at most 30, or at most 25, or at most 20, or at most 15, or at most 10. In one embodiment, the color of the thermoplastic composition is represented by an a value of at most 10, at most 9, or at most 8, or at most 7, or at most 6, or at most 5, or at most 4.8, or at most 4.5, or at most 4.3. In one embodiment, the color of the thermoplastic composition is represented by a b value of at most 15, or at most 13, at most 12, or at most 10, or at most 8, or at most 7, or at most 6.5, or at most 6.3 or at most 6.1.

In one embodiment, the color of the thermoplastic composition is represented by an L value of at most 36, or at most 35, or at most 30, or at most 25, or at most 20, or at most 15, or at most 10; and an a value of at most 10, at most 9, or at most 8, or at most 7, or at most 6, or at most 5, or at most 4.8, or at most 4.5, or at most 4.3; and a b value of at most 15, or at most 13, at most 12, or at most 10, or at most 8, or at most 7, or at most 6.5, or at most 6.3 or at most 6.1.

In one embodiment, the color of the thermoplastic composition is represented by an L value of at least 2, or at least 4. In one embodiment, the color of the thermoplastic composition is represented by an a value of at least 1, or at least 2. In one embodiment, the color of the thermoplastic composition is represented by a b value of at least 4, or at least 6, or at least 8, or at least 10.

In one embodiment, the color of the thermoplastic composition is represented by an L value of at least 2, or at least 4; and the color of the thermoplastic composition is represented by an a value of at least 1, or at least 2; and the color of the thermoplastic composition is represented by a b value of at least 4, or at least 6, or at least 8, or at least 10.

The L, a, and b values indicates values for the color of the thermoplastic composition. These values may be determined by DIN EN ISO 11664 and may be measured by any device, which allows measurement of the CIELab color space. The inventors of the current application surprisingly found out that the use of the lignin-based filler resulted in a very much black colored thermoplastic composition.

In one embodiment, the thermoplastic composition has opacity of at least 90%, or at least 95%, or at least 98%. The opacity shows how transparent or translucent the thermoplastic composition is. The opacity may be measured by the BYK Spectro-guide 45/0 apparatus. The reference value is 100%.

The use of the lignin-based filler has the added utility of making the thermoplastic composition sortable through NIR-techniques and thus recyclable as it does not mask the NIR reflectance of the polymer in the thermoplastic composition and thus allows sorting of the thermoplastic composition from a mixture of articles and thus enabling recycling of the thermoplastic composition. Further, the thermoplastic composition as disclosed in the current specification has the added utility of showing a black color rather similar to that provided by carbon black.

### EXAMPLES

Reference will now be made in detail to various embodiments.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

### Example 1—Preparing Thermoplastic Compositions and Testing the Same

In this example the purpose was to evaluate sorting of whether the prepared thermoplastic compositions into different fractions can be made by using a near-infrared detection system.

The effect of different lignin-based fillers in different amounts in the thermoplastic compositions was tested. In addition, comparative examples were prepared by using carbon black (CB) in thermoplastic compositions instead of the lignin-based filler.

Two different types of lignin-based fillers were tested. The lignin-based filler, which is marked as LBF in this example, was prepared by following the description provided above in the current specification by using lignin material from enzymatic hydrolysis process of wood and subjected to hydrothermal carbonization treatment. Further thermoplastic compositions were prepared by using pristine lignin (PL) as the lignin based filler. Pristine lignin was derived from the same enzymatic hydrolysis process of wood as the LBF lignin but it was not subjected to the hydrothermal carbonization treatment. The carbon black (CB) used in the comparative examples was MONARCH® 800 provided by Cabot. Properties of the lignin-based filler, and the pristine lignin were measured and are presented in the below table:

TABLE 1
Properties of lignin-based fillers named LBF and PL

| Value | Measurement | | | |
|---|---|---|---|---|
| measured | method | Unit | LBF | PL |
| STSA | ASTM D6556 | m²/g | 49.3 | 9.3 |
| Density | ISO 21687 | g/cm³ | 1.3-1.4 | 1.3-1.4 |
| C content | DIN 51732 | % | 65.93 | 60.3 |
| H content | DIN 51732 | % | 5.57 | 5.90 |
| N content | DIN 51732 | % | 0.11 | 0.76 |
| S content | DIN 51732 | % | 0.03 | <0.05 |
| Ash Content | DIN 51719 | % | 2.3 | 0.4 |
| Solubility | As described | % | 26.2 | 40.8 |
| 0.1M NaOH | in this | | | |
| | specification | | | |
| pH | ASTM D1512 | — | 8.4 | 6-7 |
| Moisture | ASTM D1509 | % | 0.7 | 2.4 |
| content | | | | |

The carbon content of the carbon black was >95% and the density was 1.8 g/cm3.

Firstly the following masterbatches were prepared:

TABLE 2
Prepared masterbatches

| | | | | | Ethylene |
|---|---|---|---|---|---|
| Filler | Poly- | Poly- | Poly- | Poly- | vinyl |
| type | propylene | styrene | ethylene | amide | acetate |
| 40 | x | x | x | x | x |
| weight-% | | | | | |
| carbon | | | | | |
| black | | | | | |
| 40 | x | x | x | x | x |
| weight-% | | | | | |
| pristine | | | | | |
| lignin | | | | | |
| 40 | x | x | x | x | x |
| weight-% | | | | | |
| lignin- | | | | | |
| based | | | | | |
| filler | | | | | |

The masterbatches thus contained: 40 weight-% of filler, 52 weight-% of the polymer, and in total 8 weight-% of an additive package (consisting of 2% of Ca-stearate (lubricant), 2% of Irganox 1010 antioxidant, 4% of polyethylene wax (lubricant)).

3 kg of each type of masterbatch was made, and this was done at a 40 weight-% filler-loading. The produced masterbatches were then physically dry blended at 3 weight-%. The following compositions were prepared:
Polypropylene (PP) as a masterbatch in Polypropylene (PP) (PP thermoplastic composition)
Polystyrene (PS) as a masterbatch in Ac-rylonitrile butadiene styrene (ABS) (ABS thermoplastic composition)
Polyethylene (PE) as a masterbatch in High-density polyethylene (HDPE) (HDPE thermoplastic composition)
Polyamide (PA) as a masterbatch in Polyamide (PA12) (PA12 thermoplastic composition)
Ethylene vinyl acetate (EVA) as a masterbatch for Polyvinylchloride PVC (PVC thermoplastic composition)

The prepared thermoplastic compositions each contained the amount of the different fillers presented in the tables 3-9.

Different thermoplastic compositions were prepared by using different polymers and fillers and by varying the amount of the filler. Some of the samples were prepared as flat plaques and some as granules.

The granules were prepared as follows:

Compounding of the samples was done on a Leistritz ZSE27 with underwater pelletizer. The extruder that was used for compounding of the samples was the Leistritz ZSE 27 MAXX. It is a high speed co-rotating twin screw extruder with a screw diameter of 27 mm and a L/D of 48. It contains an atmospheric and vacuum degas port, a side feeder for fillers and can be equipped with a melt pump and gas injection units for foaming. The setup was equipped with a Gala PLU Underwater pelletizing system to pelletize the extruded materials into granules.

The flat plaques were prepared as follows:

The above prepared granule samples were injection moulded on an ARBURG 420 M allrounder 1000-350. The machine was equipped with a quick change mould for ISO certified test specimens. Plaques were prepared in this manner for the other thermoplastic compositions than for the one prepare with PVC.

For the thermoplastic composition prepared with PVC, the above prepared granule samples were extruded on a Weber CE5.2 conical twin screw extruder with degas port. At its maximum RPM's of 30, the extruder had an output of around 80 kg/h. The sample strips were made with a 70 mm×5 mm die and then machined into T-bars with a tabletop CNC milling machine.

The prepared samples were analyzed by subjecting the samples to measurements done with a handheld near-infrared (NIR) spectroscopy device from trinamiX GmbH (Ludwigshafen, Germany), i.e. trinamix NIR Spectrometer (software package: general plastic).

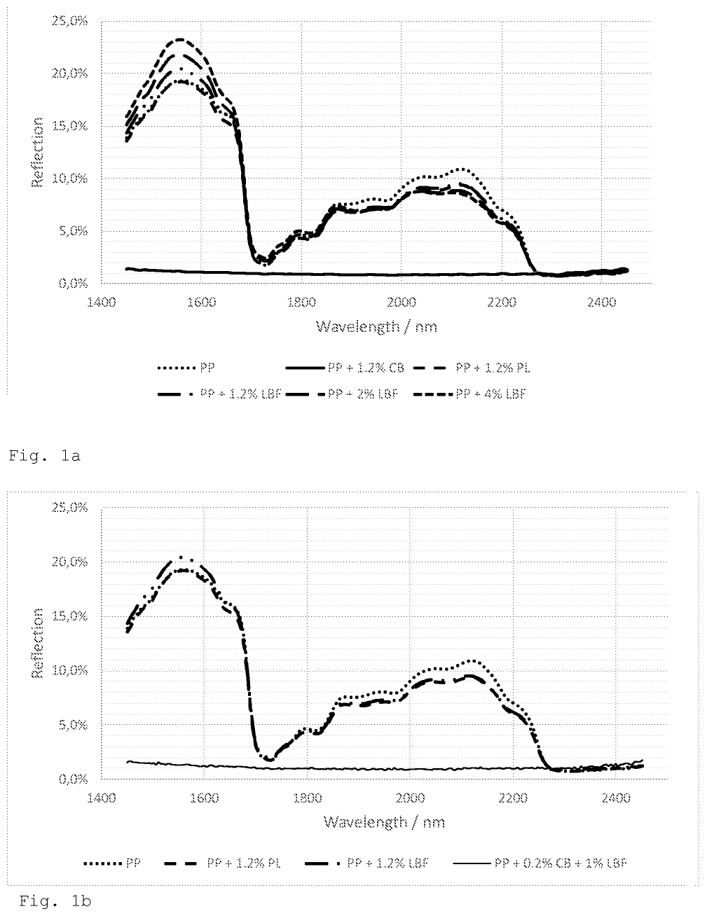

The different prepared samples and their properties and measurement results are presented in the below tables and in FIGS. 1-8. The “Scoring” in the tables denotes the results given by the measurement equipment. “ND” detects as “not detectable”.

TABLE 3
Samples of thermoplastic composition prepared
with polypropylene (PP) as the polymer and the sample
type being plaque.

| Polymer | PP | PP | PP | PP | PP | PP | PP |
|---|---|---|---|---|---|---|---|
| Amount of | — | 1.2% | — | — | — | — | 0.2% |
| CB | | | | | | | |
| Amount of | — | — | 1.2% | — | — | — | — |
| PL | | | | | | | |
| Amount of | — | — | — | 1.2% | 2.0% | 4.0% | 1.0% |
| LBF | | | | | | | |
| Max. | 19.3% | 1.4% | 19.2% | 20.4% | 21.8% | 23.2% | 1.8% |
| Reflection | | | | | | | |
| Intensity | | | | | | | |
| Min. | 0.7% | 0.8% | 0.7% | 0.8% | 0.8% | 0.8% | 0.8% |
| Reflection | | | | | | | |
| Intensity | | | | | | | |
| NIR | 26.6 | 0.8 | 26.4 | 24.5 | 26.3 | 28.0 | 1.3 |
| specimen | | | | | | | |
| contrast | | | | | | | |
| L | 67.74 | 7.5 | 21.15 | 12.93 | 9.77 | 8.28 | 8.01 |
| a | −1.12 | 0.42 | 9.63 | 4.67 | 4.43 | 4 | 0.41 |
| b | −1.05 | 1.37 | 13.49 | 6.58 | 5.72 | 4.94 | 1.42 |
| Opacity | 54% | 101% | 91% | 101% | 102% | 104% | 101% |
| Scoring- | PP | ND | PP | PP | PP | PP | ND |
| Material | | | | | | | |

The results are presented in FIGS. 1a and 1b.

TABLE 4
Samples of thermoplastic composition prepared with polypropylene
(PP) as the polymer and the sample type being granule

| Polymer | PP | PP | PP | PP |
|---|---|---|---|---|
| Amount of CB | — | 40.0% | — | — |
| Amount of PL | — | — | 40.0% | — |
| Amount of LBF | — | — | — | 40.0% |
| Max. Reflection | 20.2% | 3.3% | 33.1% | 43.5% |
| Intensity | | | | |
| Min. Reflection | 1.8% | 1.9% | 3.4% | 7.2% |
| Intensity | | | | |
| NIR specimen | 10.2 | 0.7 | 8.7 | 5.0 |
| contrast | | | | |
| Scoring - Material | PP | ND | PP | PP |

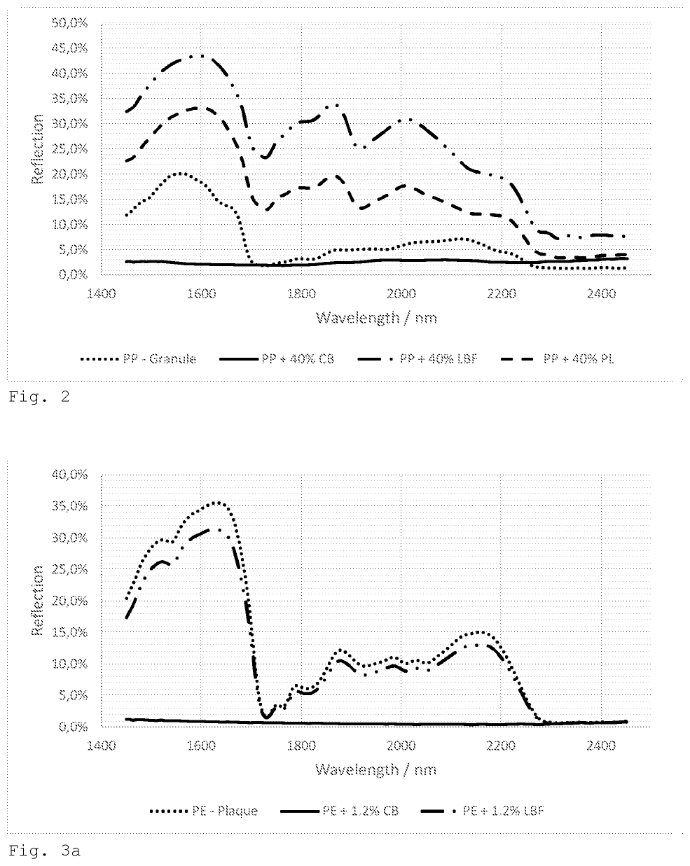

The results are presented in FIG. 2.

TABLE 5
Samples of thermoplastic composition prepared with
polyethylene (high-density polyethylene HDPE) as
the polymer and the sample type being plaque

| Polymer | HDPE | HDPE | HDPE | HDPE |
|---|---|---|---|---|
| CB | — | 1.2% | — | — |
| PL | — | — | 1.2% | — |
| LBF | — | — | — | 1.2% |
| Max. Reflection | 35.6% | 1.2% | 31.6% | 31.3% |
| Intensity | | | | |
| Min. Reflection | 0.6% | 0.4% | 0.6% | 0.5% |
| Intensity | | | | |
| NIR specimen | 58.3 | 2.0 | 51.7 | 61.6 |
| contrast | | | | |
| L | 75.42 | 7.86 | 17.9 | 10.24 |
| a | −1.17 | −0.59 | 9.72 | 3.95 |
| b | −2.2 | −1.35 | 11.52 | 4.94 |
| Opacity | 52% | 100% | 85% | 100% |
| Scoring - | HDPE | ND | HDPE | HDPE |
| Material | | | | |

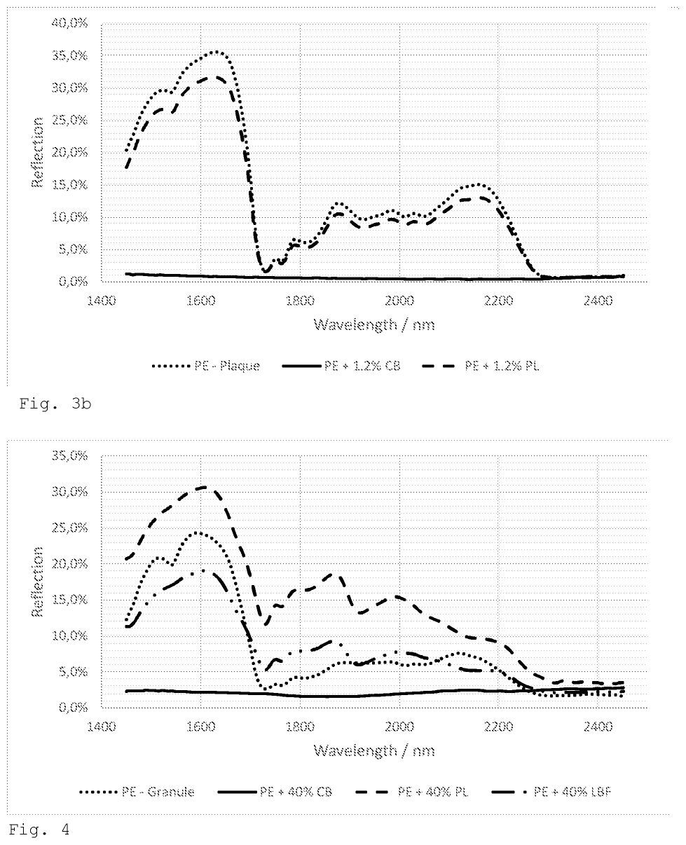

The results are presented in FIGS. 3a and 3b.

TABLE 6
Samples of thermoplastic composition prepared with
polyethylene (high-density polyethylene HDPE)
as the polymer and the sample type being granule

| Polymer | HDPE | HDPE | HDPE | HDPE |
|---|---|---|---|---|
| CB | — | 40.0% | — | — |
| PL | — | — | 40.0% | — |
| LBF | — | — | — | 40.0% |
| Max. Reflection | 24.3% | 2.8% | 30.6% | 19.1% |
| Intensity | | | | |
| Min. Reflection | 1.6% | 1.5% | 3.3% | 2.1% |
| Intensity | | | | |
| NIR specimen | 14.2 | 0.9 | 8.3 | 8.1 |
| contrast | | | | |
| Scoring - | HDPE | ND | HDPE | HDPE |
| Material | | | | |

The results are presented in FIG. 4.

TABLE 7
Samples of thermoplastic composition prepared with polyamide
(PA) as the polymer and the sample type being plaque

| Polymer | PA12 | PA12 |
|---|---|---|
| CB | 2.0% | — |
| PL | — | — |
| LBF | — | 2.0% |
| Max. Reflection | 1.4% | 27.0% |
| Intensity | | |
| Min. Reflection | 0.7% | 1.0% |
| Intensity | | |
| NIR specimen | 1.0 | 26.0 |
| contrast | | |
| L | 3.69 | 8.32 |
| a | −0.24 | 3.02 |
| b | −1.33 | 3.53 |
| Opacity | 104% | 104% |
| Scoring - | ND | PA |
| Material | | |

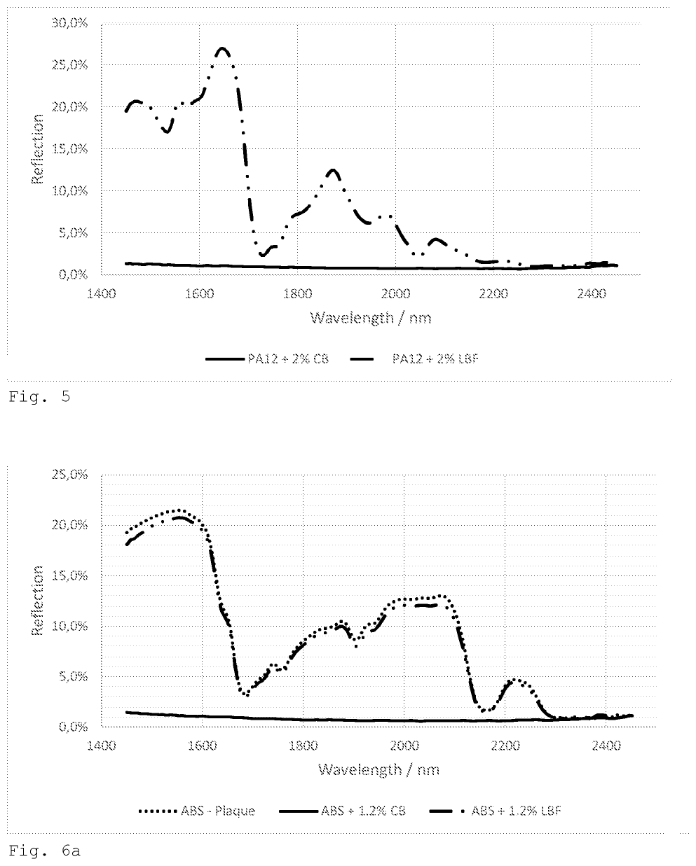

The results are presented in FIGS. 5a and 5b.

TABLE 8
Samples of thermoplastic composition prepared with
acrylnitril-butadien-styrol-copolymere (ABS) as
the polymer and the sample type being plaque

| Polymer | ABS | ABS | ABS | ABS |
|---|---|---|---|---|
| CB | — | 1.2% | — | — |
| PL | — | — | 1.2% | — |
| LBF | — | — | — | 1.2% |
| Max. Reflection | 21.5% | 1.4% | 20.6% | 20.8% |
| Intensity | | | | |
| Min. Reflection | 0.8% | 0.6% | 0.9% | 0.9% |
| Intensity | | | | |
| NIR specimen | 25.9 | 1.3 | 21.9 | 22.1 |
| contrast | | | | |
| L | 82.78 | 11.46 | 35.78 | 23.09 |
| a | −2.82 | −0.52 | 5.74 | 4.63 |
| b | 3.2 | −0.68 | 7.18 | 5.84 |
| Opacity | 75% | 100% | 100% | 100% |
| Scoring - | ABS | ND | ABS | ABS |
| Material | | | | |

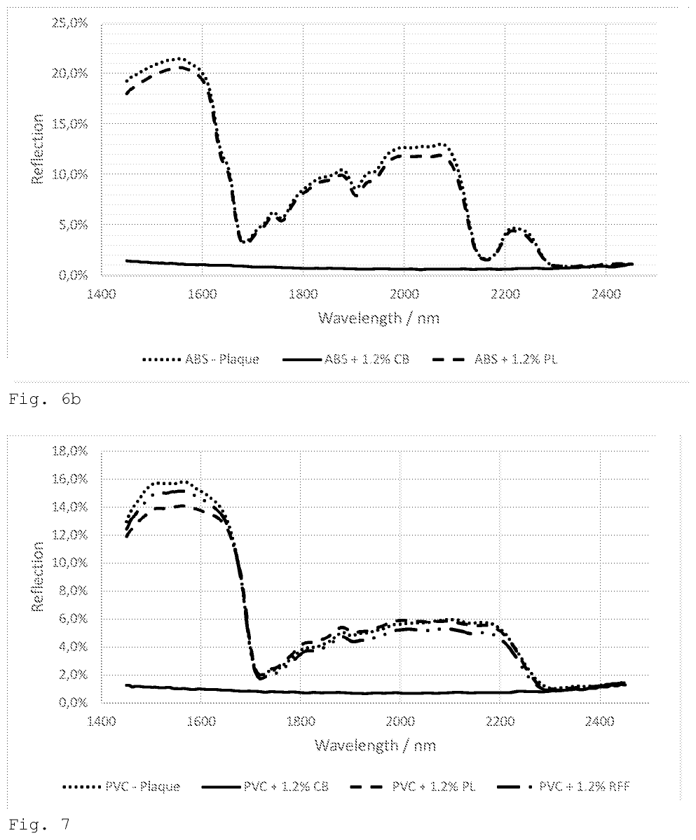

The results are presented in FIGS. 6a and 6b.

TABLE 9
Samples of thermoplastic composition prepared with Polyvinylchloride
(PVC) as the polymer and the sample type being plaque

| Polymer | PVC | PVC | PVC | PVC |
|---|---|---|---|---|
| CB | — | 1.2% | — | — |
| PL | — | — | 1.2% | — |
| LBF | — | — | — | 1.2% |
| Max. Reflection | 15.8% | 1.4% | 14.1% | 15.1% |
| Intensity | | | | |
| Min. Reflection | 1.0% | 0.7% | 0.9% | 0.8% |
| Intensity | | | | |
| NIR specimen | 14.8 | 1.0 | 14.7 | 17.9 |
| contrast | | | | |
| L | 66.53 | 11.57 | 23.04 | 16.51 |
| a | 1.44 | −0.27 | 7.35 | 2.27 |
| b | 16.83 | −0.66 | 9.63 | 2.36 |
| Opacity | 98% | 100% | 98% | 100% |
| Scoring - | PVC | ND | PVC | PVC |
| Material | | | | |

The results are presented in FIG. 7.

From the above results and FIGS. 1-7 one can see that in all cases wherein the thermoplastic composition has been prepared with a lignin-based filler (LBF or PL) to form a black color thermoplastic composition, the near-infrared reflectance of the thermoplastic composition, is not masked by the filler as is done when using carbon black. Consequently, the polymer type may be verified and the detection and sorting of the thermoplastic composition is possible contrary to the situation when using carbon black as the filler. From the above results one can see that when using carbon black the polymer is masked and cannot be detected (not detected (ND)).

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A thermoplastic composition, a method, or the use, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A thermoplastic composition comprising at least one polymer and a lignin-based filler, wherein
the color of the thermoplastic composition is represented by an L value of at most 36, an a value of at most 10, and a b value of at most 15 as determined by DIN EN ISO 11664; and
the thermoplastic composition exhibits a maximum reflection intensity value in the near-infrared wavelength range of 1450-2450 nm of the electromagnetic spectrum that is equal to or greater than 5% reflection intensity when determined with a near-infrared detection system.

2. The thermoplastic composition of claim 1, wherein the lignin-based filler comprises or consists of lignin.

3. The thermoplastic composition of claim 1, wherein the lignin-based filler is prepared from lignin subjected to hydrothermal carbonization treatment.

4. The thermoplastic composition of claim 1, wherein the thermoplastic composition is a recyclable and sortable thermoplastic composition.

5. The thermoplastic composition of claim 1, wherein the thermoplastic composition exhibits a maximum reflection intensity value in the near-infrared wavelength range of 1450-2450 nm of the electromagnetic spectrum that is equal to or greater than 8% reflection intensity when determined with a near-infrared detection system.

6. The thermoplastic composition of claim 1, wherein the thermoplastic composition exhibits a near-infrared specimen contrast that is equal to or greater than 3.0 in the wavelength range of 1450-2450 nm.

7. The thermoplastic composition of claim 1, wherein the thermoplastic composition contains 0.1-65 weight-% of the lignin-based filler based on the total weight of the thermoplastic composition.

8. The thermoplastic composition of claim 1, wherein the polymer is polyethylene, polypropylene, polystyrene, ethylene-vinyl acetate, polybutylene adipate terephthalate, polyamide, polyacrylate, polyester, acrylonitrile butadiene styrene, polycarbonate, polylactic acid, or polyvinyl chloride, or any combination or mixture of these.

9. A method for producing a thermoplastic composition comprising at least one polymer and a lignin-based filler, wherein the method comprises;
combining the at least one polymer and the lignin-based filler to form a thermoplastic composition, wherein
the color of the thermoplastic composition is represented by an L value of at most 36, an a value of at most 10, and a b value of at most 15 as determined by DIN EN ISO 11664; and
the thermoplastic composition exhibits a maximum reflection intensity value in the near-infrared wavelength range of 1450-2450 nm of the electromagnetic spectrum that is equal to or greater than 5% reflection intensity when determined with a near-infrared detection system.

10. The method of claim 9, wherein the lignin-based filler comprises or consists of lignin.

11. The method of claim 9, wherein the lignin-based filler is prepared from lignin subjected to hydrothermal carbonization treatment.

12. The method of claim 9, wherein combining the at least one polymer and the lignin-based filler comprises preparing a masterbatch and then compounding the masterbatch with the at least one polymer.

13. The method of claim 9, wherein combining the at least one polymer and the lignin-based filler comprises directly compounding the polymer and the lignin-based filler.

14. The method of claim 9, wherein the method comprises producing a recyclable and sortable thermoplastic composition.

15. The method of claim 9, wherein the thermoplastic composition can be detected by a near-infrared detection system such that the thermoplastic composition can be sorted from a mixture of articles.

16. The method of claim 9, wherein the thermoplastic composition exhibits a maximum reflection intensity value in the near-infrared wavelength range of 1450-2450 nm of the electromagnetic spectrum that is equal to or greater than 8% reflection intensity when determined with a near-infrared detection system.

17. The method of claim 9, wherein the thermoplastic composition exhibits a near-infrared specimen contrast that is equal to or greater than 3.0 in the wavelength range of 1450-2450 nm.

18. The method of claim 9, wherein the thermoplastic composition contains 0.1-65 weight-% of the lignin-based filler based on the total weight of the thermoplastic composition.

19. The method of claim 9, wherein the polymer is polyethylene, polypropylene, polystyrene, ethylene-vinyl acetate, polybutylene adipate terephthalate, polyamide, polyacrylate, polyester, acrylonitrile butadiene styrene, polycarbonate, polylactic acid, or polyvinyl chloride, or any combination or mixture of these.

20. Use of a lignin-based filler for the production of a thermoplastic composition comprising at least one polymer and the lignin-based filler, wherein
the color of the thermoplastic composition is represented by an L value of at most 36, an a value of at most 10, and a b value of at most 15 as determined by DIN EN ISO 11664; and
the thermoplastic composition exhibits a maximum reflection intensity value in the near-infrared wavelength range of 1450-2450 nm of the electromagnetic spectrum that is equal to or greater than 5% reflection intensity when determined with a near-infrared detection system, and wherein the thermoplastic composition can be detected by a near-infrared detection system such that the thermoplastic composition can be sorted from a mixture of articles.

21. An article comprising the thermoplastic composition of claim 1.

22. The article of claim 21, wherein thermoplastic composition has been shaped into the article by extrusion, injection molding, compression molding, blow molding, injection blow molding, injection stretch blow molding, thermoforming, vacuum forming, melt spinning, electrospinning, melt blowing, film blowing, film casting, extrusion coating, rotational molding, coextrusion, laminating, calendering, fused deposition modeling, or by any combination of these.

23. The use of the thermoplastic composition of claim 1 in a packaging, a housing, an automotive part, an aviation part, a marine part, a machine part, a sports equipment, a sports equipment part, a leisure equipment, a leisure equipment part, a tool, a part of a tool, a pipe, a membrane, a tube, a fitting, a bottle, a film, a bag, a sack, a textile, a rope, a container, a tank, an electrical component, an electronic component, a part for energy generation, a toy, an appliance, a kitchenware, a tableware, a flooring, a fabric, a medical application, a food contact material, a construction material, a drinking water application, and/or a furniture.
